(19) United States
(12) Patent Application Publication
(10) Pub. No.: US 2006/0092268 A1
(43) Pub. Date: May 4, 2006

(54) Teleconference method with a shared working space

(76) Inventors: Sang Chul Ahn, Seoul (KR); Jin Hak Kim, Seoul (KR); Hyoung Gon Kim, Seoul (KR); Ig Jae Kim, Seoul (KR)

Correspondence Address: JONES DAY, 222 EAST 41ST ST, NEW YORK, NY, 10017, US

(21) Appl. No.: 11/253,197

(22) Filed: Oct. 17, 2005

(30) Foreign Application Priority Data
Oct. 15, 2004 (KR) 10-2004-0082550

(51) Int. Cl. H04N 7/14

(52) U.S. Cl. 348/14.08

(57) ABSTRACT

The invention provides a teleconference method of sharing a working space between at least two terminals remotely interconnected through a communication network. The method includes the steps of: a) setting one of the terminals as a teleconference server terminal and the rest of terminals as client terminals; b) connecting the client terminals to the teleconference server terminal through the communication network; c) producing identifier mouse pointers by using identifiers of the participants and mouse pointer coordinates of the terminals at the teleconference server terminal; d) displaying the identifier mouse pointers on a screen of the teleconference server terminal; e) providing a shared window to each screen of the client terminals for displaying a clone of a screen of the teleconference server terminal; and f) at the teleconference server terminal, performing a mouse action based on a mouse event generated from each of the terminals.

### FIELD OF THE INVENTION

The present invention relates to a teleconference method and, more particularly, to a method for having a teleconference with a shared working space between participants.

### BACKGROUND OF THE INVENTION

Nowadays, a computer communication provides a voice chatting service using an Internet phone and a video communication service which allows face-to-face communication by using a camera, in addition to e-mail for sending words. As a video communication technology has developed, a teleconference based on the video communication technology has received wide attention. The teleconference system is an integrated multi-media system that allows a conference by sending and receiving videos as well as voice and character information in real time between more than two regions located remotely from each other. The teleconference is applied to various application fields such as a remote education, a telemedicine, a remote court, a remote monitoring system, a remote interview, and the like.

A typical example of widely known teleconference system is NetMeeting. The NetMeeting, a tool providing a video communication through the Internet, provides teleconference services to NetMeeting users through the Internet which is connected to the communication server of Microsoft. The NetMeeting provides not only a voice channel and a chatting channel but also a video channel by using a camera installed in each user's computer.

However, the conventional teleconference system has been developed with its focus on an efficient video and voice communication. Also, the system provides only a white board or a black board, which permits a sharing of the working space, without providing a function capable of sharing the working space provided in a common conference, i.e., a conference in which the participants meet together in a conference space.

Also, in an existing teleconference system, it is required to establish an additional teleconference server in addition to client computers as many as the number of the participants, so that there is a problem that the cost for providing the teleconference is increased.

### SUMMARY OF THE INVENTION

It is, therefore, an objective of the present invention to provide a teleconference method of sharing a working space between terminals remotely interconnected through a communication network by setting one of terminals as a teleconference server terminal and the rest of the terminals as client terminals.

In accordance with an aspect of the present invention, there is provided a method for having a teleconference with a shared working space and at least two participants by using at least two terminals remotely interconnected through a communication network, including the steps of: a) setting one of the terminals as a teleconference server terminal and the rest of terminals as client terminals; b) connecting the client terminals to the teleconference server terminal through the communication network; c) producing identifier mouse pointers by using identifiers of the participants and mouse pointer coordinates of the terminals at the teleconference server terminal; d) displaying the identifier mouse pointers on a screen of the teleconference server terminal; e) providing a shared window to each screen of the client terminals for displaying a clone of a screen of the teleconference server terminal; and f) at the teleconference server terminal, performing a mouse action based on a mouse event generated from each of the terminals.

In accordance with another aspect of the present invention, there is provided a method for displaying mouse pointers on a screen of a teleconference server terminal in a teleconference set by one teleconference server terminal and at least one client terminal remotely interconnected through a communication network, the method including the steps of: a) acquiring information related to face videos of participants and mouse pointer coordinates from the client terminals and the teleconference server terminal; b) producing face mouse pointers on the basis of the information related to the participant videos and the mouse pointer coordinates; c) displaying the face mouse pointers on the screen of the teleconference server terminal; d) checking whether a mouse event is generated from each client terminal; f) if it is determined that the mouse event is generated, updating a position of the face mouse pointer of the client terminal generating the mouse event on the screen of the teleconference server terminal.

In accordance with further another aspect of the present invention, there is provided a computer-readable record medium storing program instructions for having a teleconference with a shared working space and at least two participants by using at least two terminals remotely interconnected through a communication network, the program instructions performing the steps of: a) setting one of the terminals as a teleconference server terminal and the rest of terminals as client terminals; b) connecting the client terminals to the teleconference server terminal through a communication network; c) producing face mouse pointers by using face videos of the participants and mouse pointer coordinates of the terminals at the teleconference server terminal; d) displaying the face mouse pointers on a screen of the teleconference server terminal; e) providing a shared window to each displaying unit of the client terminals for displaying a clone of a screen of the teleconference server terminal; and f) at the teleconference server terminal, performing a mouse action based on a mouse event generated from each of the terminals.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram showing a teleconference system for sharing a working space in accordance with the present invention;

FIG. 2 is a flowchart depicting a process for producing a face mouse pointer in accordance with the present invention;

FIG. 3 is a flowchart showing an operation for processing a mouse event in accordance with the present invention;

FIG. 4 is a flowchart showing an operation for transferring a file to a teleconference server terminal when a mouse external drag-and-drop event is generated;

FIG. 5 is a flowchart showing the execution of the program installed in the teleconference server terminal when the mouse event is the mouse click event;

FIG. 6 is a diagram showing a file transfer to the teleconference server terminal in accordance with the present invention; and

FIG. 7 is a diagram showing a status where a file transfer is completed in accordance with the present invention.

FIGS. 8A to 8D are diagrams showing a process providing a shared working space in a teleconference system in accordance with the present invention.

### DETAILED DESCRIPTION OF THE PRESENT INVENTION

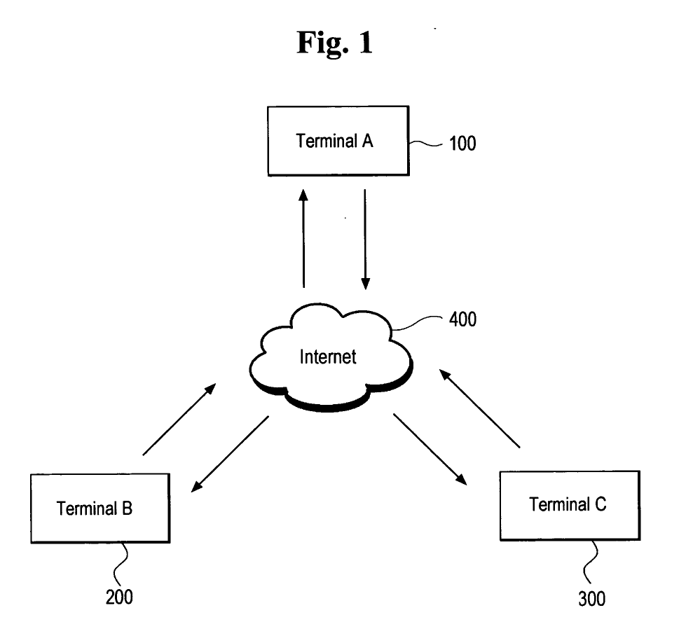

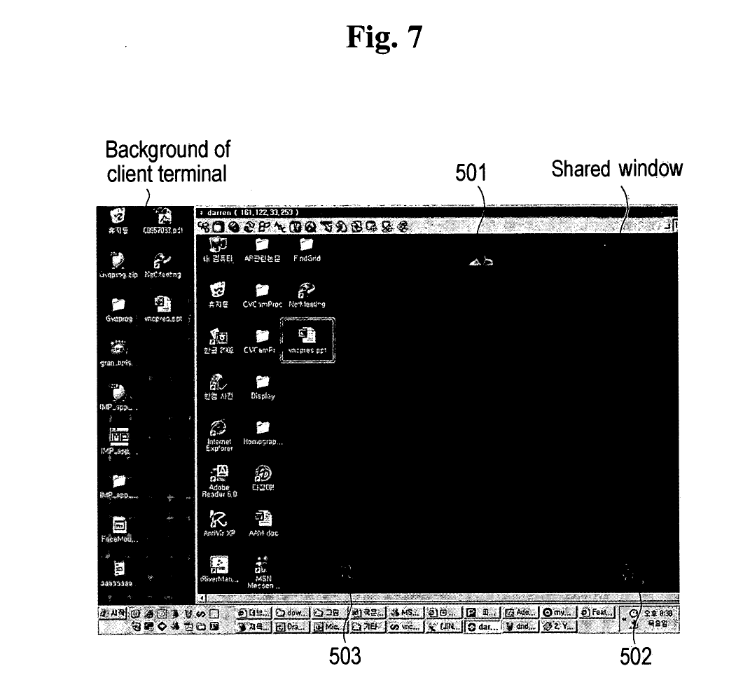

Hereinafter, a preferred embodiment of the present invention will be described by referring to FIGS. 1 and 7.

FIG. 1 is a block diagram schematically showing a teleconference system for sharing a working space in accordance with the preferred embodiment of the present invention.

Referring to FIG. 1, the teleconference system includes a plurality of terminals 100, 200 and 300, which are interconnected through Internet 400. The terminals 100, 200 and 300 are computing devices, each having an intercommunication function using TCP/IP. A desktop computer, a laptop computer or an arbitrary computer can be used as the computing device. For the sake of convenience, the desktop computer will be described as an example of the terminal in accordance with the present invention. At least two terminals are remotely interconnected in the teleconference system. The teleconference system in which three terminals are remotely interconnected will be described in accordance with the present invention. Internet 400 should be interpreted and understood as a communication network in which the conventional wired and wireless communication networks are interconnected.

Also, a remote desktop control program is installed in each terminal to remotely control terminals of each other. The remote desktop control program is to perform instructions of (1) setting one of the terminals as a teleconference sever terminal and rest terminals as a client terminal; (2) providing a shared window to a screen of each client terminal; (3) displaying a clone of a screen of a teleconference server terminal on the shared window provided to each client terminal; (4) when a mouse event is generated from the client terminals, transferring information related to the mouse event and mouse pointer coordinates to the teleconference server terminal and performing a corresponding mouse action on the basis of the transferred information in the teleconference server terminal such as program execution, file transfer or the like; and (5) transferring information related to participant face videos and the mouse pointer coordinates to the teleconference server terminal, displaying a face mouse pointer on the screen of the server terminal and changing the position of the face mouse pointer whenever the transferred mouse pointer coordinates are changed.

A well-known remote desktop control program such as virtual network computing (VNC) is used as the desktop control program in accordance with the present invention. When the desktop control program installed in each terminal is executed, one of the terminals is set as a teleconference server terminal and the rest of the terminals are set as a client terminal. For the sake of convenience, terminal A 100 operates as a teleconference server, and terminal B 200 and terminal C 300 act as the client server in accordance with the present invention.

If terminal B 200 and terminal C 300 are connected to terminal A 100 through Internet 400 by executing the remote desktop control program installed in terminal B 200 and terminal C 300, each of terminals 100, 200 and 300 acquires information related to videos of the teleconference participants. The videos of the participants are used as the participant identifiers to clearly indicate each participant in accordance with the present invention. The videos of the participants are acquired through cameras (not shown) installed in each terminal and backgrounds of each video of the participants are subtracted to obtain a face video of each participant. Information related to the face videos acquired at terminal B 200 and terminal C 300 and mouse pointer coordinates of terminal B 200 and terminal C 300 are transferred to terminal A 100 through Internet 400. Also, information on a face video of the participant using terminal A 100 is acquired through a camera installed in terminal A 100, and at the same time, mouse pointer coordinates in terminal A 100 are obtained.

Face mouse pointers are produced by combining the face video of each participant with the mouse pointer coordinates in the terminal A 100. The face mouse pointer is a modification of the conventional mouse pointer, i.e., an arrow shaped mouse pointer into a participant face video with the background subtracted therefrom. That is, when a teleconference participant moves the mouse pointer by using a mouse, the face mouse pointer is moved along the mouse moving path as in the conventional mouse pointer. Although the face videos of the participants are used to produce the mouse pointer for easily indicating each participant, it will be apparent to those skilled in the art that the face videos can be replaced with such avatars indicating each participant.

In accordance with the preferred embodiment of the present invention, the face video is processed to be seen as being transparent, so that it is prevented that the face mouse pointer hides the screen underneath the face mouse pointer. Furthermore, the face video may be combined with a mouse pointer of an arrow shape to be clearly recognized as a mouse pointer. The mouse pointer of the arrow shape may be positioned at a left-up side of the face video. The face mouse pointers are displayed on the screen of terminal A 100.

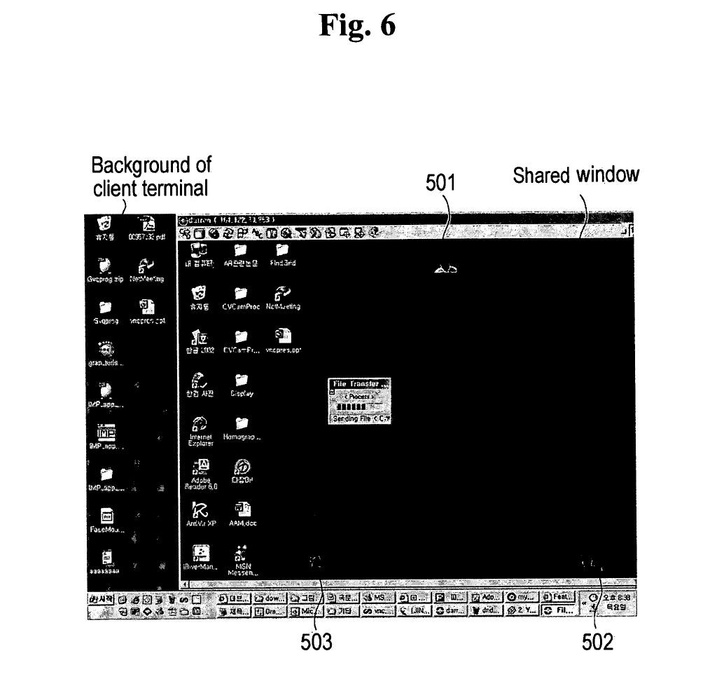

FIGS. 6 and 7 show examples of face mouse pointers in accordance with the present invention. A process displaying the face mouse pointers illustrated in FIGS. 6 and 7 will be described in details later.

Terminal A 100 displays the face mouse pointers of terminals A, B and C 100, 200 and 300 on the displaying unit of the terminal A 100. Also, the full-screen information of terminal A 100 including the face mouse pointers is transferred to terminal B 200 and terminal C 300 so as to display the clone of the screen of terminal A 100 on the shared window provided to terminal B 200 and terminal C 300.

In addition, when a mouse event is generated from terminal B 200 or terminal C 300, information related to the mouse event is transferred to terminal A 100. An appropriate mouse action such as program execution or file transfer is carried out on the basis of the information related to the mouse event transferred from the client terminal in terminal A 100. The mouse action of the file transfer may be carried out when a mouse drag-and-drop event is generated. There are two types of drag-and-drop mouse events, i.e., an internal drag-and-drop mouse event and an external drag-and-drop mouse event defined in accordance with the present invention. The internal drag-and-drop mouse event is an event where a drag-and-drop action for an object linking and embedding (OLE) object is carried out in one terminal. The external drag-and-drop mouse event is an event where the drag-and-drop action for the OLE object is performed in separate terminals by using the remote desktop control program.

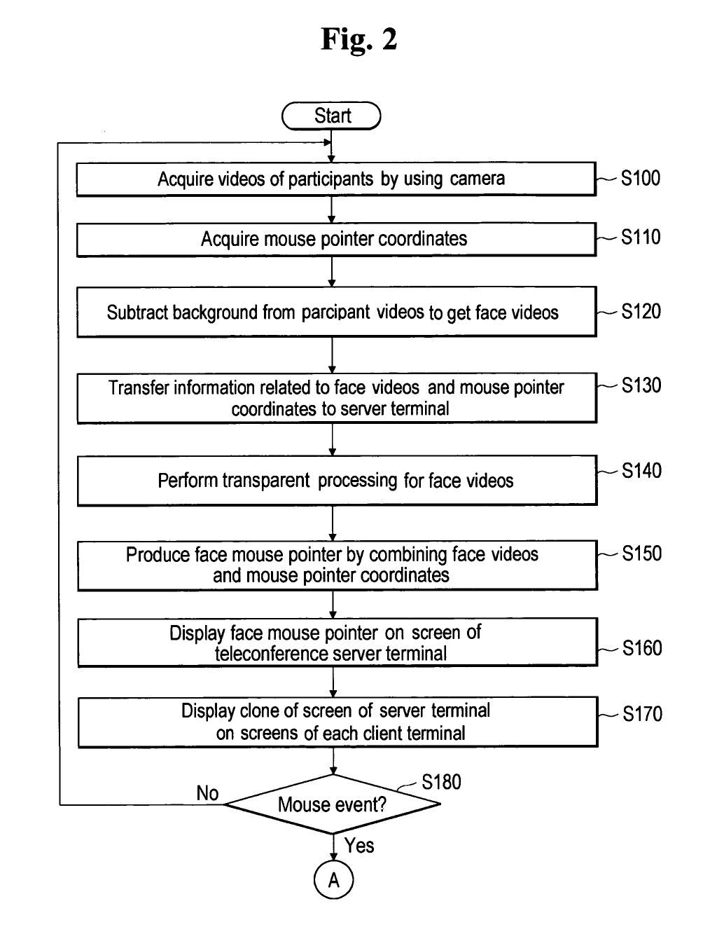

Hereinafter, the present invention will be described in detail by referring to FIGS. 2 to 7.

FIG. 2 is a flowchart depicting a process for producing the face mouse pointer in accordance with the preferred embodiment of the present invention.

Referring to FIG. 2, if terminal B 200 and terminal C 300 are connected to the terminal A 100 (hereinafter, referred to as a teleconference sever terminal) through Internet 400 by executing the remote desktop control program installed in each terminal, the camera installed in each terminal including the teleconference server terminal and the client terminals are driven, so that videos of the participants are acquired at step S100. Also, the mouse pointer coordinates in each terminal are acquired at step S110. Face videos of the participants are extracted by subtracting the backgrounds from the videos of the participants at step S120. At this step, the background is subtracted by using a well-known method. Thereafter, information on the extracted face videos and the mouse pointer coordinates is transferred to the teleconference server terminal at step S130.

A transparent processing is carried out upon the extracted face video at the teleconference server terminal at step 140. The reason for performing the transparent processing is to prevent the mouse pointer from hiding the screen underneath the mouse pointer.

The face mouse pointers are produced by combining the face video with the mouse pointer coordinates in teleconference server terminal 100 at step S150 and then the face mouse pointers are displayed on the screen of teleconference server terminal 100 at step S160.

At step S170, if all face mouse pointers are displayed on the screen of teleconference server terminal 100, the full-screen information of terminal A 100 including the face mouse pointers is transferred to the client terminals, so that the clone of the screen of the teleconference server terminal 100 is displayed on the shared window provided to the screens of each client terminal at step S170.

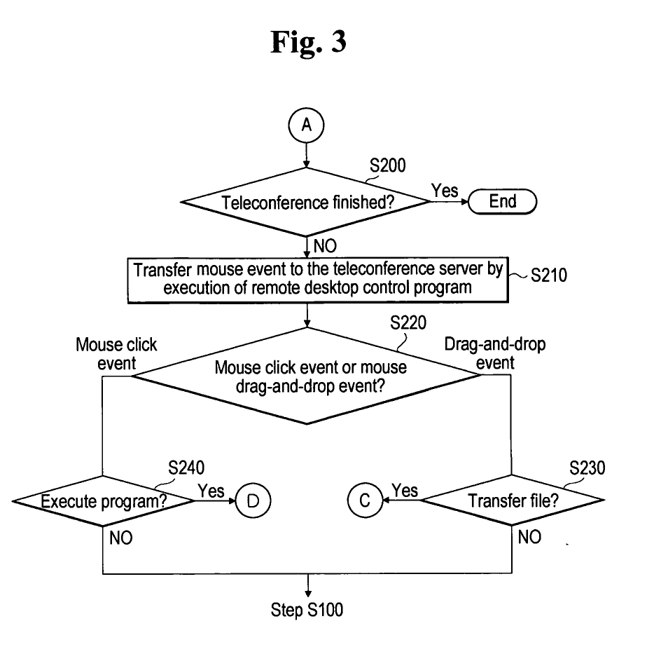

Thereafter, it is checked whether a mouse event such as the mouse click event or the mouse external drag-and-drop event is generated at step S180. If it is determined that the mouse event is generated, the process depicted in FIGS. 3 to 5 is carried out. On the other hand, if it is determined that the mouse event is not generated, the process returns to the step S100. The detailed process depicted in FIGS. 3 to 5 will be described.

FIG. 3 is a flowchart showing an operation for processing a mouse event in accordance with the present invention.

Referring to FIG. 3, it is checked whether the teleconference is finished at step S200. If it is determined that the teleconference is not finished at step S200, the information on the mouse event is transferred to teleconference server terminal 100 through Internet 400 by the execution of the remote desktop control program at step S210.

At step S220, teleconference server terminal 100 checks whether the mouse event is a mouse click event or an external drag-and-drop mouse event on the basis of the received information related to the mouse event. If it is determined that the mouse event is a mouse external drag-and-drop event at step S220, teleconference server terminal 100 checks whether files are transferred from the client terminal generating the mouse drag-and-drop event at step S230.

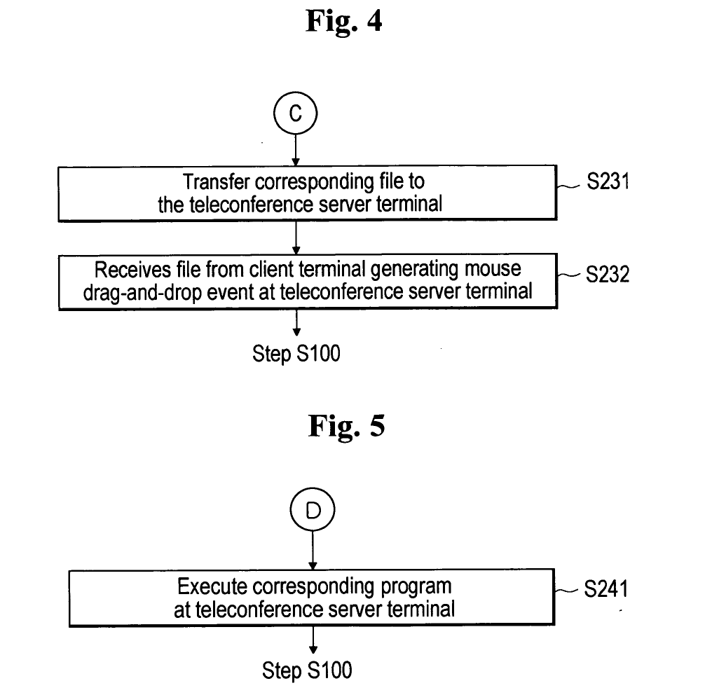

At step S230, if it is determined that the file is transferred to the teleconference sever terminal 100 from the client terminal generating drag-and-drop mouse event, the process goes to step S231 shown in FIG. 4.

FIG. 4 is a flowchart showing an operation for transferring files to teleconference server terminal when the mouse external drag-and-drop event is generated at step S230 of FIG. 3.

Referring to FIG. 4, if the files to be transferred are dragged and dropped to the shared window displaying the clone of the screen of the teleconference server terminal, the files are transferred to teleconference server terminal 100 by the execution of the remote desktop control program at step S231 and teleconference server terminal 100 receives the files from the client terminal generating the drag-and-drop mouse event at step S232 as depicted in FIG. 4.

FIG. 6 is a diagram showing the file transfer to the teleconference server terminal in accordance with the preferred embodiment of the present invention and FIG. 7 is a diagram showing a status where the file transfer is completed.

An example of the screen displayed on the displaying units of the terminal operating as a client, i.e., the client terminal, is shown in FIGS. 6 and 7. Referring to FIGS. 6 and 7, the backgrounds of the client terminals are shown in the screens. Also, a clone of the screen of the teleconference server terminal 100 is displayed on the shared window provided to the screen of the client terminal by the execution of the remote desktop control program as described by referring to FIG. 2. The shared window is used as the shared working space in accordance with the preferred embodiment of the present invention. Furthermore, there are provided face mouse pointers 501, 502 and 503 using the face videos of the teleconference participants on the shared window as mentioned above.

Referring to FIG. 6, in order to transfer a file “vncpres.ppt” from the client terminal to the teleconference server terminal, the file “vncpres.ppt” is dragged and dropped from the background of the client terminal to the shared window by using the mouse. Then a pop-up window indicating the file transfer is displayed on the screen and the file “vncpres.ppt” is transferred to teleconference server terminal 100 by the execution of the remote desktop control program as shown in FIG. 7.

When the file transfer is completed, the file “vncpres.ppt” equally in the background of the client terminal as well as the shared window, i.e., the screen of the teleconference server terminal 100 as shown in FIG. 7.

Referring back to FIG. 3, if the mouse event is a mouse click event at step S220, the teleconference server terminal 100 checks whether the client terminal generating the mouse click event intends to execute a program installed in the teleconference server terminal 100 on the basis of the information on the mouse event at step 240. If it is determined that the client terminal generating the mouse click event executes the program installed in the teleconference server terminal 100 at step S240, the corresponding program is executed in teleconference server terminal 100.

FIG. 5 is a flowchart showing the execution of the program installed in the teleconference server terminal when the mouse event is a mouse-click event at step S220 of FIG. 3.

Referring to FIG. 5, the program for the mouse click event is executed at step 241. The execution of a program such as file copy, file deletion or folder open except for the file transfer between the separated terminals is implemented in teleconference server terminal 100. Thereafter, steps S100 to S180 are carried out.

Although the transfer of voice information during the teleconference is not mentioned above, the teleconference method in accordance with the present invention may transmit voice by using a conventional voice transfer method, e.g., Speak freely etc. and provide a chatting window together with white- or black-board.

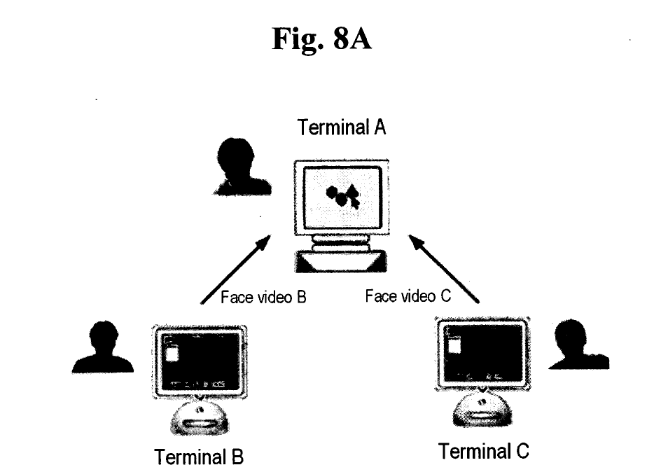

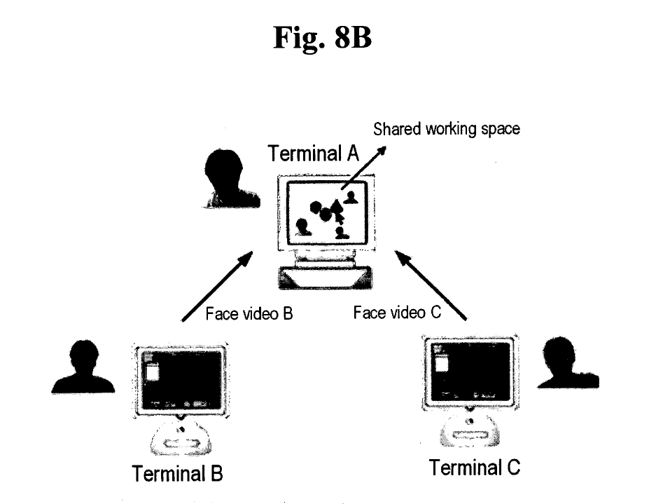

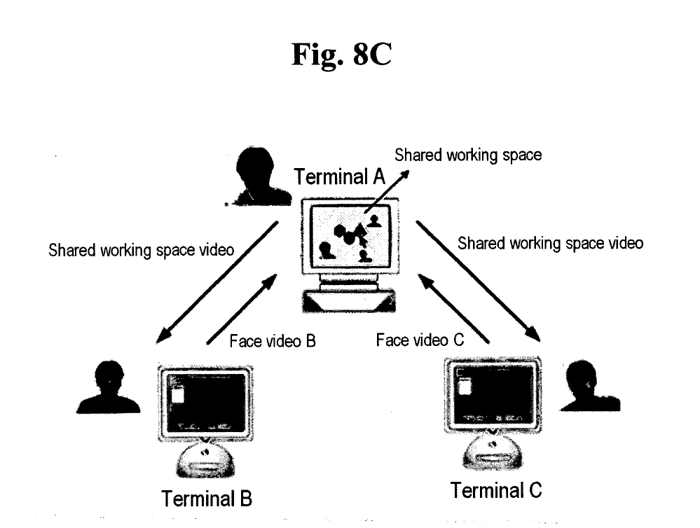

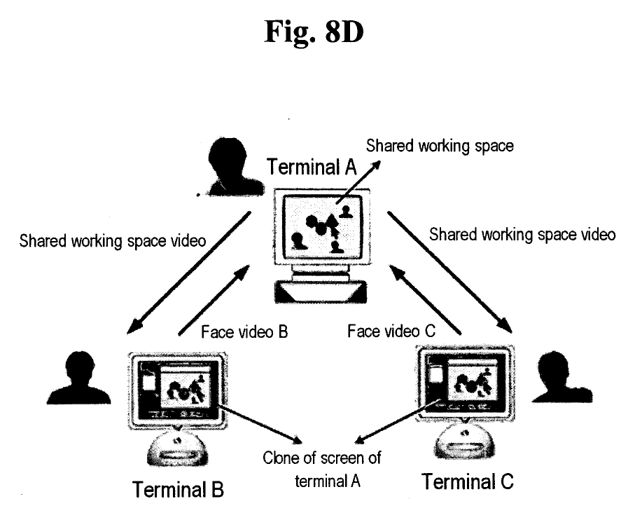

FIGS. 8A to 8D are diagrams graphically showing a process providing a shared working space in the teleconference system in accordance with the present invention.

As shown in FIG. 8A, the face videos of the participants using the terminals B and C, which are the client terminals, is acquired through the cameras installed in each client terminal, and then the information on the face videos is transferred to the terminal A, which is the teleconference server terminal. The information on the mouse pointer coordinates of each client terminal is transferred together with the information on the face videos at the same time. Also, the face video of the participant using the teleconference server terminal is acquired.

The teleconference server terminal produces the face mouse pointers of respective terminals A, B and C by combining the face videos and the mouse pointer coordinates as shown in FIG. 8B. At this time, the screen of the terminal A displaying the face mouse pointers of each terminal is used as the shared working space.

After completing the production of the face mouse pointers in the terminal A, the information on the screen of the terminal A is transferred to the client terminals, terminal B and terminal C, as shown in FIG. 8C. The information on the screen of the terminal A is transferred by using the VNC in accordance with the present invention.

Thereafter, the shared window is provided in each screen of the terminals B and C on the basis of the execution of the remote desktop control program, and then the clone of the screen of the terminal A is displayed on the shared window of each client terminal as shown in FIG. 8D.

Since the face mouse pointers using the face videos of the teleconference participants are provided in accordance with the present invention, the mouse pointer of each participant can be easily identified, so that a work of each participant in the teleconference is clearly recognized.

Also, since every terminal for the teleconference can be used as a teleconference server, a separate teleconference server is not needed in the present invention and the screen of teleconference server terminal operating as a teleconference server is also displayed on the screen of the client terminal operating as a client, so that the working space can be shared between the terminals.

In accordance with the preferred embodiment of the present invention, an example of the face mouse pointer applied to the teleconference is described; however, it is apparent to a person skilled in the art that the technology using a face mouse system can be applied to various fields such as a remote education, a telemedicine, a remote court, a remote monitoring system, a remote interview, and the like.

Since the position of the face mouse pointer is dynamically changed according to a change of the mouse pointer coordinates, the desktop space can be used efficiently and an interaction with the working space is possible with the face mouse pointer. For example, when a participant of the teleconference wishes to point a certain part of the document, the participant can place the face mouse pointer to that certain part and point it with the face mouse pointer for other participants' attention.

While the present invention has been described and illustrated with respect to a preferred embodiment of the invention, it will be apparent to those skilled in the art that variations and modifications are possible without deviating from the broad principles and teachings of the present invention which should be limited solely by the scope of the claims appended hereto.

What is claimed is:

1. A method for having a teleconference with a shared working space and at least two participants by using at least two terminals remotely interconnected through a communication network, comprising the steps of:
a) setting one of the terminals as a teleconference server terminal and the rest of terminals as client terminals;
b) connecting the client terminals to the teleconference server terminal through the communication network;
c) producing identifier mouse pointers by using identifiers of the participants and mouse pointer coordinates of the terminals at the teleconference server terminal;
d) displaying the identifier mouse pointers on a screen of the teleconference server terminal;
e) providing a shared window to each screen of the client terminals for displaying a clone of a screen of the teleconference server terminal; and
f) at the teleconference server terminal, performing a mouse action based on a mouse event generated from each of the terminals.

2. The method as recited in claim 1, wherein the identifiers are face videos of the participants.

3. The method as recited in claim 2, wherein the step c) includes the steps of:
c1) acquiring information related to videos of the participants and the mouse pointer coordinates of the terminals;
c2) subtracting a background from each video of the participants to get the face videos of the participants;
c3) transferring information related to the face videos and the mouse pointer coordinates to the teleconference server terminal;
c4) producing face mouse pointers by combining the face videos and the mouse pointer coordinates; and
c5) combining a mouse pointer of an arrow shape with the face mouse pointers.

4. The method as recited in claim 3, wherein the step c) further includes the step of performing a transparent processing upon the face mouse pointer.

5. The method as recited in claim 1, wherein the step f) includes the steps of:
f1) checking whether a mouse event is generated from the client terminals;
f2) if it is determined that the mouse event is generated, transferring information related to the mouse event and mouse pointer coordinates to the teleconference server terminal; and
f3) performing the mouse action and changing a position of the corresponding face mouse pointer on the basis of the transferred information related to the mouse event.

6. The method as recited in claim 5, wherein the step f3) includes the steps of:
f31) checking a type of the mouse event;
f32) if it is determined that the mouse event is a mouse external drag-and-drop event for file transfer, transferring a corresponding file to the teleconference server terminal; and
f33) if it is determined that the mouse event is a mouse click event for program execution, executing a corresponding program installed in the teleconference server.

7. A method for displaying mouse pointers on a screen of a teleconference server terminal in a teleconference set by one teleconference server terminal and at least one client terminal remotely interconnected through a communication network, the method comprising the steps of:
a) acquiring information related to face videos of participants and mouse pointer coordinates from the client terminals and the teleconference server terminal;
b) producing face mouse pointers on the basis of the information related to the participant videos and the mouse pointer coordinates;
c) displaying the face mouse pointers on the screen of the teleconference server terminal;
d) checking whether a mouse event is generated from each client terminal; and
f) if it is determined that the mouse event is generated, updating a position of the face mouse pointer of the client terminal generating the mouse event on the screen of the teleconference server terminal.

8. The method as recited in claim 7, wherein the step a) includes the steps of:
a1) acquiring information related to videos of the participants and the mouse pointer coordinates of the terminals;
a2) subtracting backgrounds from each participant video to get the face videos of the participants; and
a3) transferring information related to the face videos and the mouse pointer coordinates to the teleconference server terminal.

9. The method as recited in claim 8, wherein the step b) includes the steps of:
b1) performing a transparent processing upon the face mouse pointers; and
b2) combining a mouse pointer of an arrow shape with the face mouse pointers.

10. A computer-readable record medium storing program instructions for having a teleconference with a shared working space and at least two participants by using at least two terminals remotely interconnected through a communication network, the program instructions performing the steps of:
a) setting one of the terminals as a teleconference server terminal and the rest of terminals as client terminals;
b) connecting the client terminals to the teleconference server terminal through a communication network;
c) producing face mouse pointers by using face videos of the participants and mouse pointer coordinates of the terminals at the teleconference server terminal;
d) displaying the face mouse pointers on a screen of the teleconference server terminal;
e) providing a shared window to each displaying unit of the client terminals for displaying a clone of a screen of the teleconference server terminal; and
f) at the teleconference server terminal, performing a mouse action based on a mouse event generated from each of the terminals.

11. The computer-readable record medium as recited in claim 10, wherein the step c) includes the steps of:
c1) acquiring information related to videos of the participants and the mouse pointer coordinates of the terminals;
c2) subtracting a background from each participant video to get the face videos of the participants;
c3) transferring information related to the face videos and the mouse pointer coordinates to the teleconference server terminal;
c4) producing face mouse pointers by combining the face videos with the mouse pointer coordinates;
c5) combining a mouse pointer of an arrow shape with the face mouse pointers.

12. The computer-readable record medium as recited in claim 11, wherein the step c) further includes the step of performing a transparent processing upon the face mouse pointer.

13. The computer-readable record medium as recited in claim 10, wherein the step f) includes the steps of:
f1) checking whether a mouse event is generated from the client terminals;
f2) if it is determined that the mouse event is generated, transferring information related to the mouse event and mouse pointer coordinates to the teleconference server terminal; and
f3) performing the mouse action and changing a position of the corresponding face mouse pointer on the basis of the transferred information related to the mouse event.
